(19) United States
(12) Patent Application Publication
(10) Pub. No.: US 2020/0152212 A1
(43) Pub. Date: May 14, 2020

(54) SYSTEMS AND METHODS FOR COMPRESSING AUDIO DATA FOR STORAGE AND STREAMING FROM AN AIRCRAFT

(71) Applicant: L3 TECHNOLOGIES, INC., New York, NY (US)

(72) Inventors: Eduardo M. Carro, Sarasota, FL (US); Michael E. Weed, Nokomis, FL (US)

(21) Appl. No.: 16/675,911

(22) Filed: Nov. 6, 2019

Related U.S. Application Data
(60) Provisional application No. 62/757,862, filed on Nov. 9, 2018.

(51) Int. Cl. G10L 19/012; G10L 19/16; G10L 25/93

(52) U.S. Cl. CPC G10L 19/012; G10L 25/93; G10L 19/167

(57) ABSTRACT

A system and method of streaming silence-edited audio data from an aircraft is provided. The European Union Aviation Safety Agency (EASA) has dictated that there needs to be a reliable way to recover data from channels recorded onboard an aircraft. The system and method include a silence editing unit which removes periods of silence from an audio signal and maintains a tracking of the time period during which the silence persists. Information of the time period during which the silence persists is transmitted, along with the silence-edited audio signal, via a streaming satellite signal, to be re-constructed at a reception end.

### CROSS REFERENCE TO RELATED APPLICATION

This application claims the benefit under 35 USC 119(e) of prior co-pending U.S. Provisional Patent Application No. 62/757,862, filed Nov. 9, 2018, the disclosure of which is hereby incorporated by reference in its entirety.

### BACKGROUND

### Field

The present disclosure relates to streaming transmission of data from an aircraft, and more particularly to satellite streaming of silence-edited audio from a non-CAM source on an aircraft.

### Description of Related Art

Recently, the European Union Aviation Safety Agency (EASA) has dictated that there needs to be a reliable way to recover data from channels recorded onboard an aircraft. Typically, an aircraft includes at least four different recorded channels: a cockpit area microphone (CAM), the pilot's microphone, the co-pilot's microphone, and an auxiliary channel.

Audio and data streaming via satellite is considered a possible way of addressing these EASA requirements. However, satellite bandwidth is very costly and limited, and reducing the amount of data being transmitted is desirable.

### SUMMARY

One or more example embodiments may address at least the above problems and/or disadvantages and other disadvantages not described above. Also, exemplary embodiments are not required to overcome the disadvantages described above, and may not overcome any of the problems described above.

One or more example embodiments may provide a system and apparatus which reduce the bandwidth necessary to transmit non-CAM channels and other audio sources.

According to an aspect of an example embodiment, a method of transmitting aircraft flight data comprises receiving an audio signal from an audio source comprising at least one of a pilot's microphone, a co-pilot's microphone, and an auxiliary audio source within an aircraft; detecting at least one period of silence within the audio signal; replacing the period of silence with a first digital tag and a second digital tag; tracking a time during which the period of silence persists in the audio signal; and streaming the audio signal, in which the period of silence is replaced with the first digital tag and the second digital tag, along with information identifying a time during which the silence persists.

The tracking the time may comprise maintaining a count of silenced samples within the audio signal.

The tracking the time may comprise tagging a plurality of audio channel packets with respective times thereof.

The detecting the at least one period of silence may comprise comparing the audio signal to a threshold parameter.

The detecting the at least one period of silence and the replacing the period of silence with the first digital tag and the second digital tag may be performed by a silence editing unit; and the method may further comprise, digitally compressing and digitally decompressing the audio signal prior to transmitting the audio signal to the silence editing unit.

The streaming the audio signal may comprise controlling the streaming of the audio signal based on a streaming trigger generate by trigger logic.

According to an aspect of another example embodiment, a non-transitory computer-readable medium storing thereon software instructions which, when executed by a processor, cause the processor to perform a method comprising: receiving an audio signal from an audio source comprising at least one of a pilot's microphone, a co-pilot's microphone, and an auxiliary audio source within an aircraft; detecting at least one period of silence within the audio signal; replacing the period of silence with a first digital tag and a second digital tag; tracking a time during which the period of silence persists in the audio signal; and streaming the audio signal, in which the period of silence is replaced with the first digital tag and the second digital tag, along with information identifying the time during which the silence persists.

According to an aspect of another example embodiment, a cockpit voice recorder (CVR) comprises a receiver configured to receive an audio signal; a tag detector configured to detect at least one period of silence within the audio signal and to digitally replace the period of silence with a first digital tag and a second digital tag; trigger logic configured to transmit a digital trigger; and a streaming audio output configured to output a digital data stream comprising the audio signal in which the period of silence is replaced with the first digital tag and the second digital tag, along with information identifying a time during which the silence persists, based on receipt of the digital trigger.

### BRIEF DESCRIPTION OF THE DRAWINGS

The above and/or other example aspects and advantages will become apparent and more readily appreciated from the following description of example embodiments, taken in conjunction with the accompanying drawings in which:

FIG. 1 is a diagram of an aircraft data management system according to an example embodiment;

FIG. 2 illustrates the streaming audio transmitter according to an example embodiment;

FIG. 3 illustrates a silence editing module according to an example embodiment; and

FIG. 4 illustrates a streaming audio receiver according to an example embodiment.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including”, “comprise, and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list. In addition, the terms such as “unit,” “-er (-or),” and “module” described in the specification refer to an element for performing at least one function or operation, and may be implemented in hardware, software, or the combination of hardware and software.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described here in detail.

Methods illustrated in the various figures may include more, fewer, or other operations, and operations may be performed in any suitable order. Connecting lines shown in the various figures are intended to represent example functional relationships and/or physical couplings between and among the various elements. One or more alternative or additional functional relationships or physical connections may be present in a practical system.

One or more systems and methods described herein may enable the storage of extended duration audio to a Cockpit Voice Recorder (CVR) or other device that is compliant with the EUROCAE ED112A Minimum Operational Performance Specification for crash protected airborne recorder, or similar systems. The extended duration audio may be stored while also providing for the streaming of audio from the non-CAM or other audio channels to be stopped during periods of audio silence, for example using silence editing, in order to save transmission bandwidth. As the streaming of data from an aircraft can be performed via satellite or wireless transmission, a reduction in the necessary data bandwidth may also provide a reduction of cost.

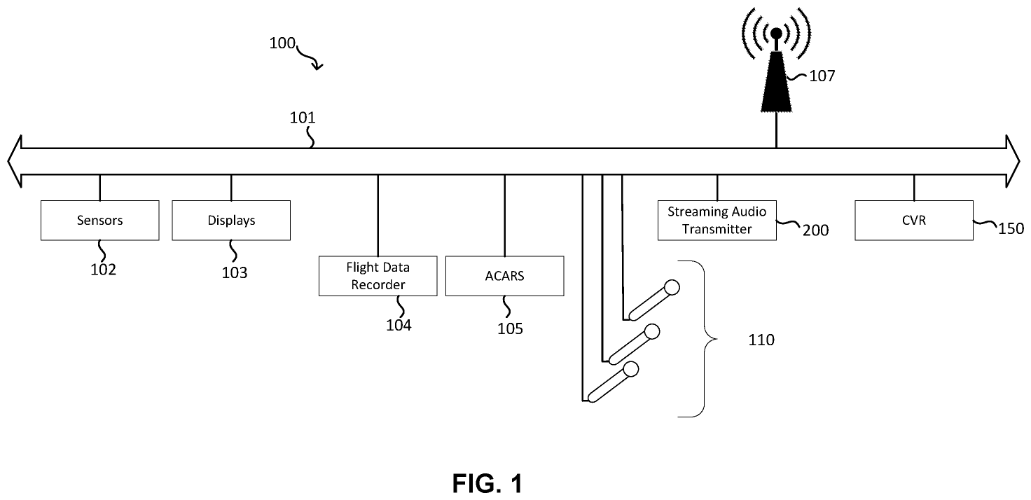

FIG. 1 is a diagram of an aircraft data management system 100, according to an example embodiment. The system 100 includes a digital bus 101 which transfers information among various systems and equipment aboard the aircraft. The system 100 includes a plurality of sensors 102 which sense flight data and parameters such as, but not limited to airspeed, altitude, rudder position, and aircraft acceleration data. A plurality of microphones 110 are placed at predetermined locations throughout the cockpit and elsewhere in the aircraft and capture voice and other analog audio. The microphones 110 may include, but are not limited to, a cockpit area microphone (CAM), the pilot's microphone, the co-pilot's microphone, and an auxiliary channel.

The system 100 may also optionally include an Aeronautical Radio, Incorporated (ARINC) Communications Addressing and Reporting System (ACARS) 105 which may be used for telemetry of data and messages between the aircraft and ground stations. In many systems, data to be transmitted from the aircraft is formatted for transmission and send to ACARS 105 via the digital bus 101.

A cockpit voice recorder (CVR) 150 is additionally included in the system 100. It is coupled to the microphones 110, and may include any number of recording media, including, but not limited to, a digital semiconductor memory device. The CVR may receive signal(s) from the microphones 110 via the bus 101 or a local bus (not shown) and convert the audio signal(s) to a format suitable for storage in a recorder. The conversion of the signal(s) may include digital compression.

According to an example embodiment, the system 100 also includes a streaming audio transmitter 200, also illustrated with respect to FIGs. A, B, and C. A satellite transmitter 107 is also coupled to the bus 101. Alternately, the satellite transmitter may be coupled directly to the streaming audio transmitter 200.

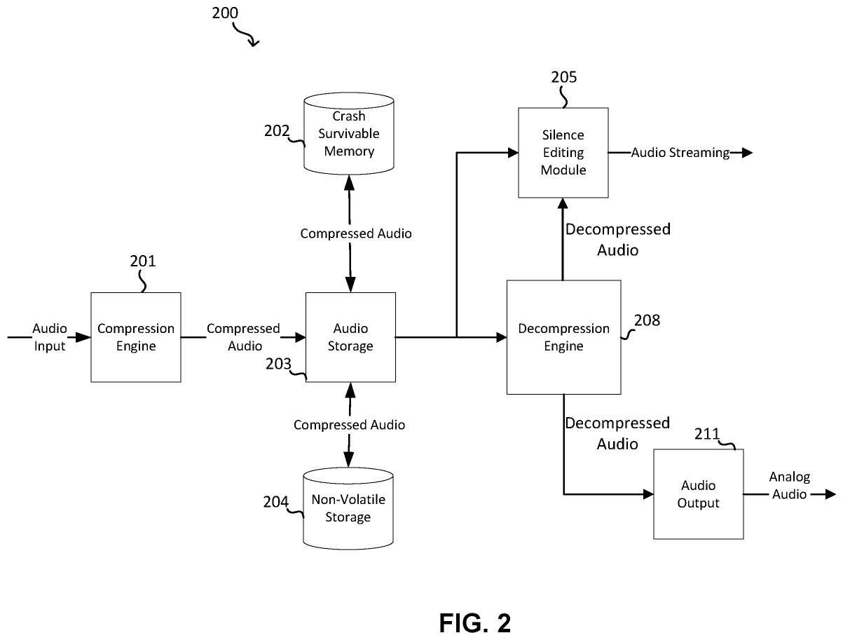

FIG. 2 illustrates the streaming audio transmitter 200 according to an example embodiment. According to this example embodiment, the streaming audio transmitter 200 receives an audio input from the microphones 110. The audio input is received by a compression engine 201 which outputs compressed digital audio. The compression engine may be any compression engine which performs compression according to method other than a psychoacoustic analysis, such as used in MPEG-1 Audio Layer III (MP3) audio compression.

The compressed digital audio is stored in an one or more storage devices, such as one or more of an audio storage 203, a crash survivable memory 202, and a non-volatile memory device 204. The compressed digital audio is also input into a decompression engine 208, which decompresses the audio which was compressed by the compression engine, and outputs decompressed audio.

The decompressed audio may be output to an audio output 211 which converts the decompressed audio into an analog audio output and transmits the analog audio to an analog audio output device, such as the displays 103, as would be understood by one of skill in the art. Alternately, the original audio input, prior to compression, may be transmitted directly from the audio source to the audio output 211 or the analog audio output.

The decompressed audio may also be transmitted to a silence editing module 205. Alternately, the silence editing module 205 may also receive the compressed digital audio from the audio storage 203. The silence editing module 205 outputs streaming audio which has been silence-edited.

The streaming audio transmitter 200 may be included in the CVR 150, for example, as a software option upgrade on existing hardware, or it may be a physically separate unit.

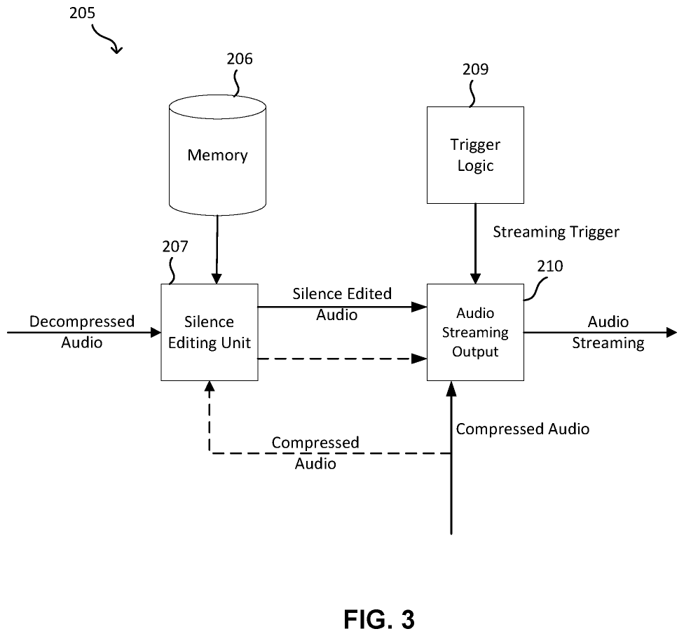

FIG. 3 illustrates a silence editing module according to an example embodiment. A memory 206 stores a silence compression process algorithm and a threshold parameter. The threshold parameter is a minimum volume, below which a the silence editing unit 207 determines that the audio stream is silent. The silence editing unit 207 determines whether a given point in time in the input audio includes an active audio signal or an inactive/silent audio signal based on a comparison to the threshold parameter. When an inactive/silent audio signal is detected, the streaming transmission of the audio, either compressed or decompressed, to an audio streaming output 210, is stopped and replaced by the transmission of a “silence start tag.” During a period of audio silence, the audio streaming output 210 maintains a count of silenced samples. When the period of audio silence ends, the audio streaming output 210 transmits the count, along with a “silence stopped tag,” for reconstructing the audio stream. Alternately, time tagging of audio channel packets may be used to enable synchronization of multiple audio channels.

The streaming of the audio is controlled by a trigger logic 209 which outputs a streaming trigger to the audio streaming output.

The audio streaming output may receive one or more of the non-silence-edited compressed audio, the silence-edited audio, and the streaming trigger. The audio streaming output may be configured to output audio streaming, for example, over an Ethernet interface.

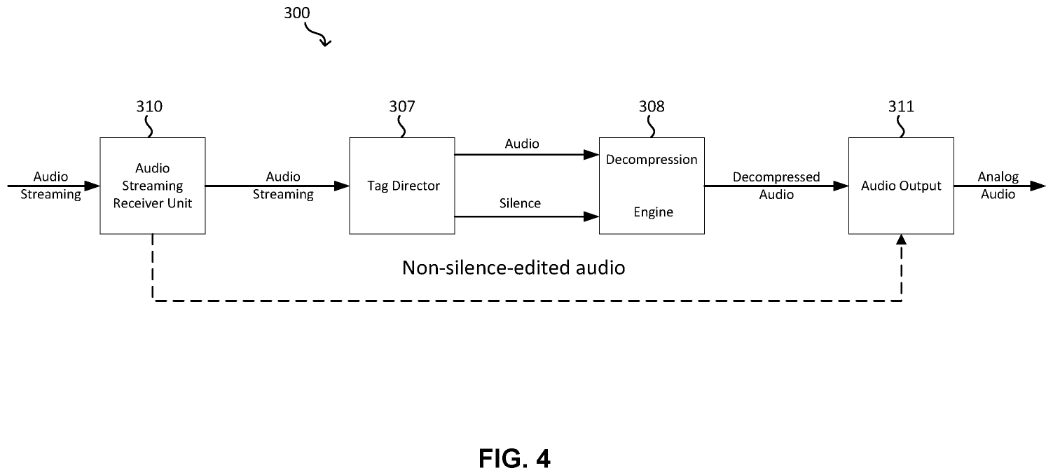

FIG. 4 illustrates a streaming audio receiver 300 according to an example embodiment. A receiver unit 310 receives the streaming audio transmitted from the audio streaming output 210 of the silence editing module 205. The receiver 300 includes a tag detector 307, that detects the tags transmitted by the silence editing module 205, and outputs both the streamed audio and silence generated based on the tags, to maintain the original timing of the audio channel.

For audio that is not silence-edited, such as a CAM channel, this may be transmitted from the receiver unit 310 to an audio output 311, bypassing the tag detector 307 and decompression engine 308.

The audio output 311 may convert the decompressed audio into an analog audio output and transmit the analog audio.

One or more example embodiments described herein may be used in aircraft by airline companies and the military. The systems, units, modules, and methods described herein may be embodied as software, stored on a non-transitory, computer-readable medium or as hardware. Such software may be stored on and/or implemented by one or more of a CVR, a Cockpit Voice and Data Recorder (CVDR), and any other suitable aircraft device, as would be understood by one of skill in the art. Alternately, the software and/or hardware embodying the apparatuses and methods described herein may be packaged as stand-alone equipment.

In the various embodiments disclosed herein, the systems, units, and modules may comprise software executed by hardware, such as a field-programmable gate array (FPGA), logic gates, or other hardware implementation.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Example embodiments may comprise or utilize a special purpose or general-purpose computer including computer hardware, as discussed in greater detail below. Example embodiments may also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, example embodiments can comprise at least two distinctly different kinds of computer-readable media: physical computer-readable storage media and transmission computer-readable media.

Physical, computer-readable storage media includes random access memory (RAM), read-only memory (ROM), electrically-erasable programmable read-only memory (EEPROM), compact disc (CD)-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that example embodiments described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. One or more example embodiments may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. A method of transmitting aircraft flight data, the method comprising:
receiving an audio signal from an audio source comprising at least one of a pilot's microphone, a co-pilot's microphone, and an auxiliary audio source within an aircraft;
detecting at least one period of silence within the audio signal;
replacing the period of silence with a first digital tag and a second digital tag;
tracking a time during which the period of silence persists in the audio signal; and
streaming the audio signal, in which the period of silence is replaced with the first digital tag and the second digital tag, along with information identifying a time during which the silence persists.

2. The method according to claim 1, wherein the tracking the time comprises maintaining a count of silenced samples within the audio signal.

3. The method according to claim 1, wherein the tracking the time comprises tagging a plurality of audio channel packets with respective times thereof.

4. The method according to claim 1, wherein the detecting the at least one period of silence comprises comparing the audio signal to a threshold parameter.

5. The method according to claim 1, wherein:
the detecting the at least one period of silence and the replacing the period of silence with the first digital tag and the second digital tag are performed by a silence editing unit; and
the method further comprises, digitally compressing and digitally decompressing the audio signal prior to transmitting the audio signal to the silence editing unit.

6. The method according to claim 1, wherein the streaming the audio signal comprises controlling the streaming of the audio signal based on a streaming trigger generate by trigger logic.

7. A non-transitory computer-readable medium storing thereon software instructions which, when executed by a processor, cause the processor to perform a method comprising:
receiving an audio signal from an audio source comprising at least one of a pilot's microphone, a co-pilot's microphone, and an auxiliary audio source within an aircraft;
detecting at least one period of silence within the audio signal;
replacing the period of silence with a first digital tag and a second digital tag;
tracking a time during which the period of silence persists in the audio signal; and
streaming the audio signal, in which the period of silence is replaced with the first digital tag and the second digital tag, along with information identifying the time during which the silence persists.

8. The non-transitory computer-readable medium according to claim 7, wherein the tracking the time comprises maintaining a count of silenced samples within the audio signal.

9. The non-transitory computer-readable medium according to claim 7, wherein the tracking the time comprises tagging a plurality of audio channel packets with respective times thereof.

10. The non-transitory computer-readable medium according to claim 7, wherein the detecting the at least one period of silence comprises comparing the audio signal to a threshold parameter.

11. The non-transitory computer-readable medium according to claim 7, wherein
the detecting the at least one period of silence and the replacing the period of silence with the first digital tag and the second digital tag are performed by a silence editing unit of the processor; and
the method further comprises, digitally compressing and digitally decompressing the audio signal prior to transmitting the audio data to the silence editing unit.

12. The non-transitory computer-readable medium according to claim 7, wherein the streaming the audio signal comprises controlling the streaming of the audio signal based on a streaming trigger generated by trigger logic.

13. A cockpit voice recorder (CVR) comprising:
a receiver configured to receive an audio signal;
a tag detector configured to detect at least one period of silence within the audio signal and to digitally replace the period of silence with a first digital tag and a second digital tag;
trigger logic configured to transmit a digital trigger;
a streaming audio output configured to output a digital data stream comprising the audio signal in which the period of silence is replaced with the first digital tag and the second digital tag, along with information identifying a time during which the silence persists, based on receipt of the digital trigger.

14. The CVR according to claim 13, wherein the streaming audio output is further configured to output the digital data stream as a plurality of audio channel packets, wherein each of the audio channel packets is tagged with a respective time thereof.
